(19) United States
(12) Patent Application Publication
(10) Pub. No.: US 2006/0069783 A1
(43) Pub. Date: Mar. 30, 2006

(54) Program, method and device for managing information shared among components, recording medium and communication apparatus

(75) Inventors: Satoshi Aihara, Saitama (JP); Hideaki Takahara, Saitama (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/236,618

(22) Filed: Sep. 28, 2005

(30) Foreign Application Priority Data
Sep. 30, 2004 (JP) JP2004-286921
Jul. 28, 2005 (JP) JP2005-219343

(51) Int. Cl. G06F 15/16; G06F 13/42

(52) U.S. Cl. 709/227; 710/105

(57) ABSTRACT

A component-shared information management method for managing information shared by a plurality of components constituting application software, is characterized in that a shared information management means receives a registration request from a processing executing component among the plurality of components, receives a specific type of information from the component and manages the information thus obtained as shared information. By adopting this method, application software in computer systems can be developed more efficiently.

### CROSS REFERENCE TO RELATED APPLICATIONS

The disclosure of Japanese Patent Application No. JP2004-286921, filed on Sep. 30, 2004, entitled “Program, Method and Device for Managing Information Shared Among Components, Recording Medium and Communication Apparatus”; JP2005-219343, filed on Jul. 28, 2005, entitled “Program, Method and Device for Managing Information Shared Among Components, Recording Medium and Communication Apparatus”. The contents of that application are incorporated herein by reference in their entirety.

### BACKGROUND OF THE INVENTION

1. Field of the Invention

The present invention relates to a program, a method and a device for managing information shared among components, a recording medium and a communication apparatus, and enables efficient development of, for instance, application software for computer systems.

2. Description of the Related Art

An application software program (hereafter referred to as application) is developed and designed for a computer system by combining a plurality of components in the related art. The application is divided into the components each corresponding to a unit of processing, and the individual components are designed separately, in correspondence to a specific processing unit.

Since the individual components are designed independently of one another, the processing in a given component is not closely tied to the processing in the other components and simple execution of the various processing units in the individual components will not achieve linkage for the processing units in the plurality of components. For this reason, it is necessary to define specific protocols among the individual components. In conformance to the protocols thus defined, the plurality of components can connect with one another to achieve linkage among them.

### SUMMARY OF THE INVENTION

As described above, in application development in the related art, it is necessary to define protocols for allowing linkage among a plurality of components. The need for such protocols arises from the fact that sufficient consideration is not taken with regard to more efficient linkage among a plurality of components in the application development in the related art.

For this reason, when common information is to be shared by a plurality of components, too, a separate protocol needs to be designed for each linkage between components. Accordingly, each component needs to be designed by taking into consideration linkages to be achieved with other components, and as the number of components to link with increases, the linkage specifications are bound to become highly complex. This, in turn, may give rise to a problem of poor productivity in application development.

An object of the present invention is to provide a program, a method and a device for managing information shared among components, with which linked processing by a plurality of linked components can be controlled and information shared among the plurality of components can be managed when developing an application for a computer system, a recording medium and a communication apparatus.

In order to achieve the object described above, the shared information management program for managing information shared among components in a first aspect of the present invention, which manages information to be shared among a plurality of components constituting application software, enables a computer to function as a shared information management means that receives a registration request from a component to execute processing among the plurality of components, receives from the component a predetermined, specific type of information and manages the information thus obtained as shared information.

The recording medium achieved in a second aspect of the present invention is a computer-readable recording medium having recorded therein the shared information management program for managing information shared among components achieved in the first aspect of the present invention.

The shared information management method for managing information shared among components achieved in a third aspect of the present invention, through which information to be shared among a plurality of components constituting application software is managed, is characterized in that a shared information management means receives a registration request from a component to execute among the plurality of components, receives a predetermined, specific type of information from the component and manages the information thus acquired as shared information.

The shared information management device for managing information shared among components achieved in a fourth aspect of the resin to invention, which manages information to be shared among a plurality of components constituting application software, includes a shared information management means that receives a registration request from a component to execute processing among the plurality of components, receives a predetermined, specific type of information from the component and manages the information thus obtained as shared information.

The communication apparatus achieved in a fifth aspect of the present invention, which is disposed between a single communication network or a plurality of communication networks and a single communication terminal or a plurality of communication terminals to enable the communication terminal to conduct information communication, includes the shared information management device achieved in the fourth aspect of the present invention.

### BRIEF DESCRIPTION OF THE DRAWINGS

FIG. 1 is a functional block diagram of the system achieved in a first embodiment;

FIG. 2 presents a system example, provided to facilitate an explanation of the operation executed by the session management means in the first embodiment;

FIG. 3 presents a flowchart of the operation executed by the session management means in the first embodiment;

FIG. 4 presents an example of items that may be managed by the session data holding unit in the first embodiment;

FIG. 5 is a functional block diagram of the system achieved in a second embodiment;

FIG. 6 presents a system example, provided to facilitate an explanation of the operation executed by the session management means in the second embodiment;

FIG. 7 presents a flowchart of the operation executed by the session management means in the second embodiment;

FIG. 8 presents an example of items that may be managed by the session data holding unit in the second embodiment;

FIG. 9 is a functional block diagram of the system achieved in a third embodiment;

FIG. 10 is a functional block diagram of the adapter unit included in the third embodiment;

FIG. 11 presents a system example, provided to facilitate an explanation of the operation executed by the session management means in the third embodiment;

FIG. 12 presents a flowchart of the operation executed by the session management means in the third embodiment; and

FIG. 13 presents a flowchart of the operation executed by the session management means in the third embodiment.

### DETAILED DESCRIPTION OF THE PREFERRED EMBODIMENTS

The shared information management programs for managing information shared among components and the shared information management methods for managing information shared among components, achieved in the individual embodiments of the present invention as explained below, enable development of application software for computer systems, which allowed pertinent processing portions in processing participated in by a plurality of components built into application software to be managed as a common portion.

### (A) First Embodiment

An explanation is given on the system achieved in the embodiment, adopted in a system that includes a plurality of components to manage information to be shared among the individual components.

### (A-1) Structure of the First Embodiment

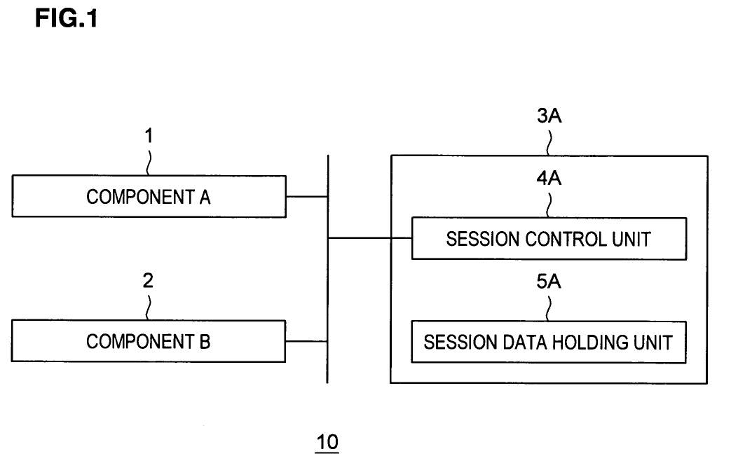

FIG. 1 is a schematic functional block diagram of the system achieved in the embodiment, showing the internal functions of a session management means. FIG. 1 shows a system 10 having two components 1 and 2, which also includes a session management means 3A.

The system 10 is software executed by a control device (not shown), which may be recorded in a computer-readable recording medium or may be stored in a storage device in a server, a computer or the like.

The components 1 and 2 each constitute an function execution unit. While an explanation is given in reference to FIG. 1 on an example in which there are two components A and B with processing contents different from each other, there is no specific limit to the number of components that may be included in the system 10. In addition, with the components 1 and 2, a plurality of sets of processing can be executed simultaneously.

The components 1 and 2 are connected with the session management means 3A, and they issue a processing request to the session management means 3A for a function execution.

The session management means 3A controls linked processing between the components 1 and 2 and also holds shared information (session data) needed by both the components 1 and 2 to execute the processing. As shown in FIG. 1, the session management means 3A includes a session control unit 4A and a session data holding unit 5A as its functions.

The session control unit 4A controls the functions of the session management means 3A. Upon receiving a processing request from the components 1 or 2, the session control unit 4A issues a command for the session data holding unit 5A to secure a storage area for storing shared information related to the session executed by the components 1 and 2. In addition, the session control unit 4A generates a session ID that will enable a univocal identification of the session executed by the components 1 and 2. The session ID thus generated by the session control unit 4A is then provided to the session data holding unit 5A and the shared information is managed by using this session ID.

In response to the command issued by the session control unit 4A, the session data holding unit 5A secures a storage area for the particular session and holds the shared information related to the particular session in the secured storage area. The session data holding unit 5A also provides the stored shared information to the session control unit 4A in response to a request from the session control unit 4A.

### (A-2) Operation Executed in the First Embodiment

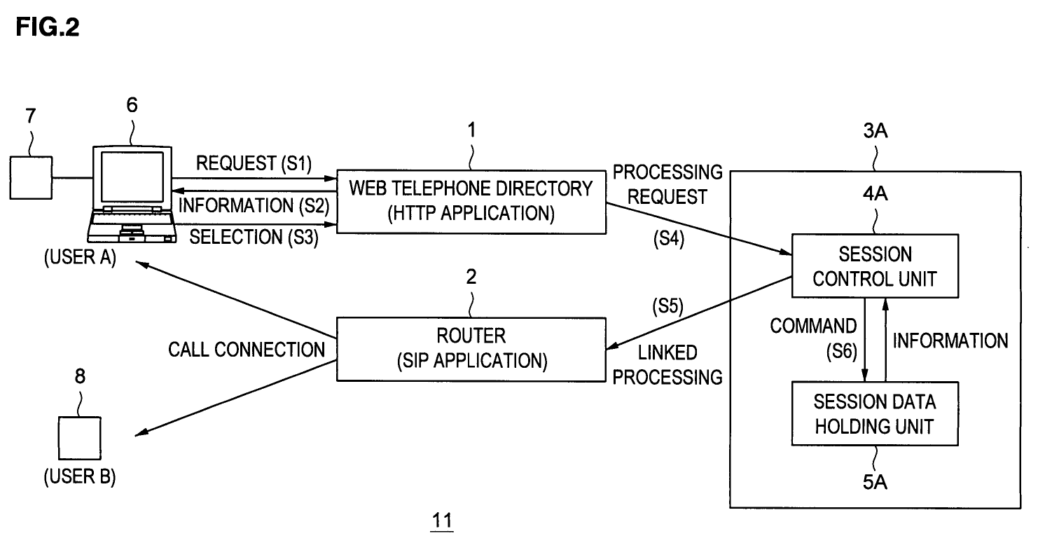

Next, the operation of the system 10 achieved in the embodiment is explained in reference to drawings. The following explanation is given on an example adopting the system configuration 11 shown in FIG. 2.

In the example presented in FIG. 2, the system 10 includes a router 2 (an SIP component) that controls audio communication by adopting an SIP (Session Initiation Protocol) and a Web telephone directory 1 (an HTTP component) that provides information (telephone directory information) on preregistered users and telephone numbers by adopting an HTTP (hypertext transfer protocol). FIG. 2 shows the operation executed in the system 10 when a user A requests a phone call to a partner (user B) selected by checking the directory information provided by the Web telephone directory 1. It is to be noted that reference numeral 6 indicates a terminal belonging to the user A, which may be, for instance, a personal computer, and reference numerals 7 and 8 indicate VOIP (voice over IP) telephones belonging to the users A and B respectively in FIG. 2.

In the example presented in FIG. 2, the session control unit 4A has already received a processing request from the components 1 or 2.

As shown in FIG. 2, in response to an operation performed by the user A, the terminal 6 issues a request to the Web telephone directory 1 for information on preregistered users and their telephone numbers (S1). In response to the request from the terminal 6, the Web telephone directory 1 provides the information on the users and their telephone numbers to the terminal 6 (S2), and the user/telephone number information is displayed at the terminal 6.

After the user/telephone number information is displayed at the terminal 6, the user A performs a specific operation to select the information on a desired call recipient (the user B in this case) and then terminal 6 issues a call connect request requesting a connection with the recipient (the user B) to the Web telephone directory 1 (S3).

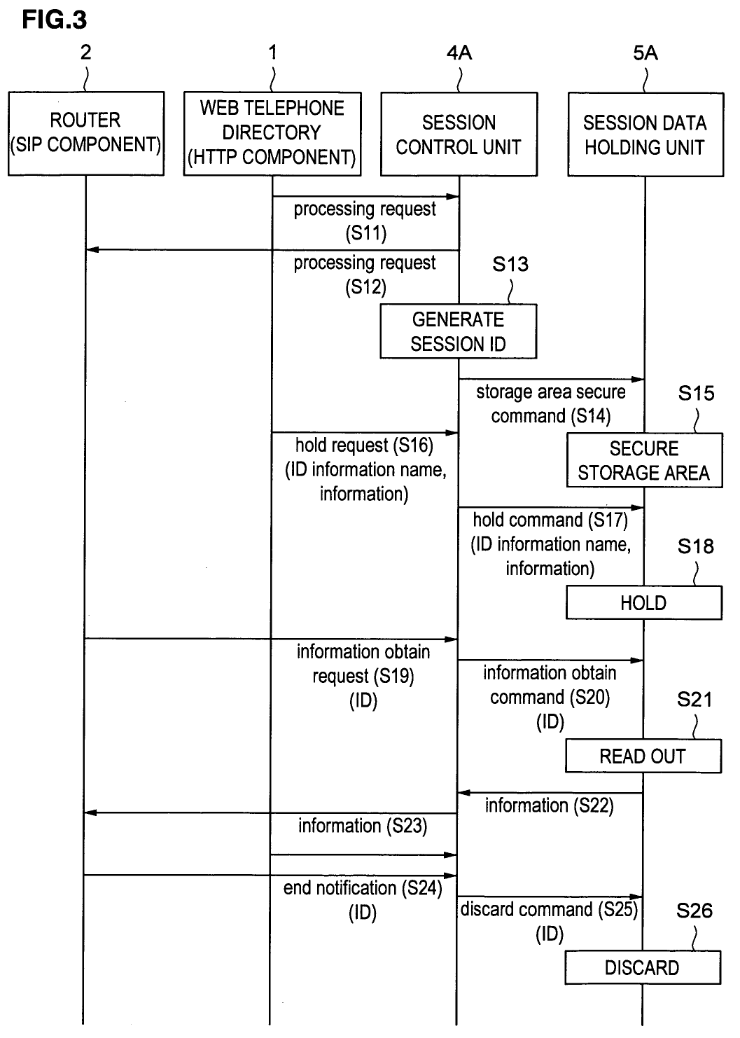

Upon receiving the call connect request, the Web telephone directory 1 issues a processing request to the session control unit 4A in order to establish a call between the user A and the user B (S4, S11 in FIG. 3).

Upon receiving the processing request, the session control unit 4A judges that a linkage between one component, i.e., the Web telephone directory 1, and another component, i.e., the router 2, needs to be achieved and, accordingly, it issues a processing request to the router 2 (S5, S12 in FIG. 3). Thus, linked processing is initiated between the Web telephone directory 1 and the router 2. It is to be noted that while it is necessary to preset a protocol for enabling a linkage between the different components, i.e., the Web telephone directory 1 and the router 2 in the related art, the session control unit 4A included in the system enables linked processing without having to preset a protocol for connecting the components.

In addition, upon receiving the processing request from the Web telephone directory 1, the session control unit 4A generates a session ID (S13 in FIG. 3) and also issues a command for the session data holding unit 5A to secure a storage area (S6, S14 in FIG. 3). In response, the session data holding unit 5A can secures a storage area where information to be shared by the components is to be held.

Upon receiving the command from the session control unit 4A, the session data holding unit 5A secures a storage area where information to be shared by the Web telephone directory 1 and the router 2 for this particular session is to be held (S15 in FIG. 3).

The session control unit 4A generates such a session ID each time a processing request is received from a component and the session ID constitutes information that enables a univocal identification of the particular processing session. The session ID thus generated is managed in correspondence to the information held at the session data holding unit 5A. The session ID is also invariably attached to data to be exchanged between the individual components and the session control unit 4A. Namely, the components 1 and 2 linked with each other both hold the session ID having been generated by the session control unit 4A.

This makes it possible to identify the specific session to which any data exchanged between the individual components and the session control unit 4A are related. In addition, the session ID can be used as a key to identify the corresponding information held at the session data holding unit 5A.

Subsequently, the component (the Web telephone directory 1 or the router 2) issues a hold request to the session control unit 4A to hold the shared information (S16 in FIG. 3). At this time, the Web telephone directory 1 provides the session control unit 4A with, at least, information indicating the session ID and the information name specifying the type of the shared information and the information itself to be held.

The term “shared information” in this context is the necessary information to be shared by the components 1 and 2 during the information to execute processing between the two components 1 and 2. This shared information is set in advance types of information to be shared with each other between the components to achieve linkage.

Upon receiving the hold request from the component 1 or 2, the session control unit 4A provides the session data holding unit 5A with the information indicating the session ID and the information name and the information itself having been received from the component 1 or 2, and the information thus received is held at the session data holding unit 5A (S17 in FIG. 3). The session data holding unit 5A, in turn, identifies the corresponding storage area based upon the session ID and stores and holds the received information in the storage area as shared information (S18 in FIG. 3).

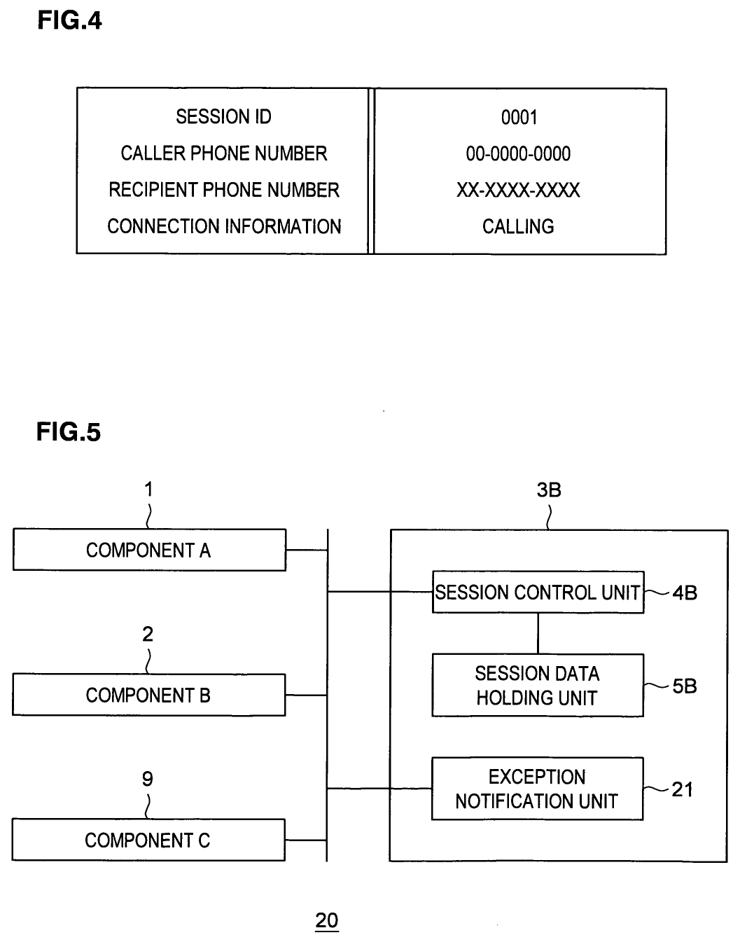

An example of management that maybe adopted in conjunction with the shared information held at the session data holding unit 5A is now explained in reference to FIG. 4.

As shown in FIG. 4, management items that may be held at the session data holding unit 5A in the embodiment include the session ID, the caller telephone number, the recipient telephone number and connection information.

The session ID is identification information generated by the session control unit 4A and the session ID in the example in FIG. 4 is “0001”. The caller telephone number and the recipient telephone number are the telephone numbers of the user A (the caller) and the user B (the recipient) in FIG. 2.

In addition, the connection information indicates the status of call connect processing executed by the router 2. Such connection information is considered to be information to be shared by the Web telephone directory 1 and the router 2 when, for instance, the Web telephone directory 1 has a function of displaying at the terminal 6 the connecting status (e.g., “calling” or “connecting”) achieved through the call connect processing executed by the router 2. It is to be noted that the connection information may be managed by allocating a storage area for a flag (with, for instance, several bits) to indicate the connecting status and by adjusting the flag setting.

By adopting the structure described above, the session data holding unit 5A is enabled to hold the shared information needed for linked processing achieved through linkage between the components 1 and 2 as common information.

Next, the operation executed to read out information held at the session data holding unit 5A is explained in reference to FIG. 3. Either component (the Web telephone directory 1 or the router 2) needing to obtain information having been saved by the component in the past or information having been saved by the other component linked to the component, issues an information obtain request to the session control unit 4A (S19).

For instance, the information obtain request is issued to the session control unit 4A by the router 2 in the example presented in FIG. 3. When issuing the information obtain request, the router 2 provides the session control unit 4A with the session ID simultaneously.

Upon receiving the information obtain request from the component 1 or 2, the session control unit 4A provides the session data holding unit 5A with the session ID and issues a command for reading out the information corresponding to the session ID (S20).

In response, the session data holding unit 5A reads out the shared information saved in the storage area corresponding to the session ID provided by the session control unit 4A (S21). The shared information thus read out is first provided to the session control unit 4A (S22) which then transfers it to the requesting component (S23).

The session holding unit 5A holds shared information in correspondence to a specific session ID and is thus able to read out the information held therein by using the session ID as a key when the information is needed.

It is to be noted that if there is no information matching the session ID the session data holding unit 5A reports back to the session control unit 4A that no matching information is present. Then, the session control unit 4A notifies the component A1, A2 of the absence of matching information by returning empty information (e.g., all zeros) to the component A1, A2. The term “empty information” in this context refers to a symbol indicating that no matching information is present.

Lastly, as the linked processing by the components 1 and 2 (the Web telephone directory 1 and the router 2) ends, the components 1 and 2 transmit end notifications to the session control unit 4A (S24). At this time, the components 1 and 2 also provide the session control unit 4A with the session ID simultaneously.

Upon verifying that end notifications from all the components 1 and 2 involved in the session have arrived, the session control unit 4A judges that the linked processing by the plurality of components 1 and 2 in this particular session has been completed and issues a command for the session data holding unit 5A to discard the shared information corresponding to the session ID (S25). Upon receiving the discard command from the session control unit 4A, the session data holding unit 5A discards the shared information corresponding to the session ID (S26). Once the processing ends, the shared information corresponding to the session is erased, as described above allowing the session data holding unit 5A to hold only necessary shared information at any time point.

### (A-3) Advantages of the First Embodiment

As explained above, the first embodiment, which includes the session control unit 4A, enables control of linked processing by the plurality of components 1 and 2. This means that allows the individual components can be designed without having to take into consideration any complicated coordination with components to link with them. As a result, the need to preset protocols among the individual components is eliminated and the application software development efficiency is improved.

### (B) Second Embodiment

In this embodiment, when an exception occurs in a component within the system, the other components operating in linkage with the component are notified of the exception.

### (B-1) Structure of the Second Embodiment

FIG. 5 is a schematic functional block diagram of the system achieved in the embodiment, showing the internal functions of the session management means. As shown in FIG. 5, a system 20 achieved in the embodiment includes three components 1, 2 and 9 and a session management means 3B.

Structurally, the system 20 achieved in the second embodiment differs from the system 10 explained in reference to the first embodiment in the functional structure of the session management means 3B. Accordingly, a detailed explanation is given below on the functional structure not explained in reference to the first embodiment and a repeated explanation of the functional structures having already been described in reference to the first embodiment is omitted.

In addition, while FIG. 5 shows the system 20 having an additional component 9, this simply indicates that the system 20 includes a plurality of components, as does the system achieved in the first embodiment, and the three components 1, 2 and 9 are shown in FIG. 5 to facilitate the explanation.

The session management means 3B in FIG. 5 includes an exception notification unit 21 in addition to a session control unit 4B and a session data holding unit 5B.

In addition to the functions of the session control unit 4A explained in reference to the first embodiment, the session control unit 4B has a function of registering the individual components 1, 2 and 9 for exception notification in response to their exception notification requests so that if an exception occurs at any of them, each registered component will be notified of the exception. The session control unit 4B may register a component for exception notification by, for instance, recording the component having issued the exception notification request into a storage area corresponding to a specific session ID held at the session data holding unit 5B. In addition, the session control unit 4B receives an exception occurrence notification from the component 1, 2 or 9 where the exception has occurred and identifies each component 1, 2 or 9 requiring the exception notification by referencing the record at the session data holding unit 5B.

The term “exception” in this context refers to an event that results when the execution of the processing having been set for the component, 1, 2 or 9 has not been carried out correctly. For instance, such an event may be a failure of the router in establishing a call connection (e.g., the recipient did not answer the phone) or a program error.

In addition to the functions of the session data holding unit 5A explained in reference to the first embodiment, the session data holding unit 5B has a function of a recording component requiring the exception notification in response to a command issued by the session control unit 4B.

When an exception occurrence notification is received from the component where the exception has occurred, the exception notification unit 21 issues the exception notification to the component requiring the exception notification.

### (B-2) Operation Executed in the Second Embodiment

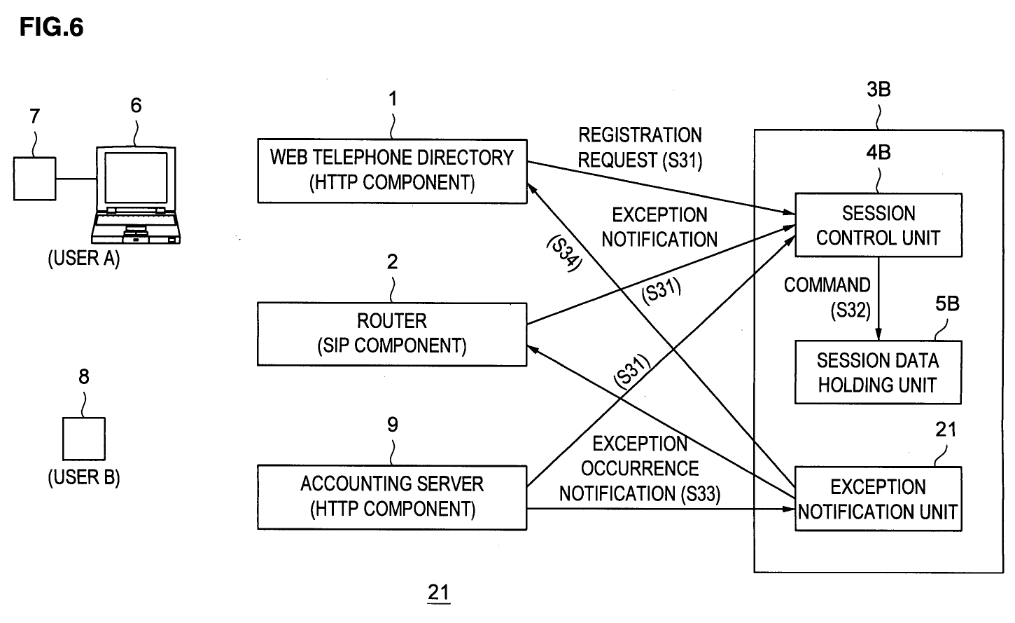

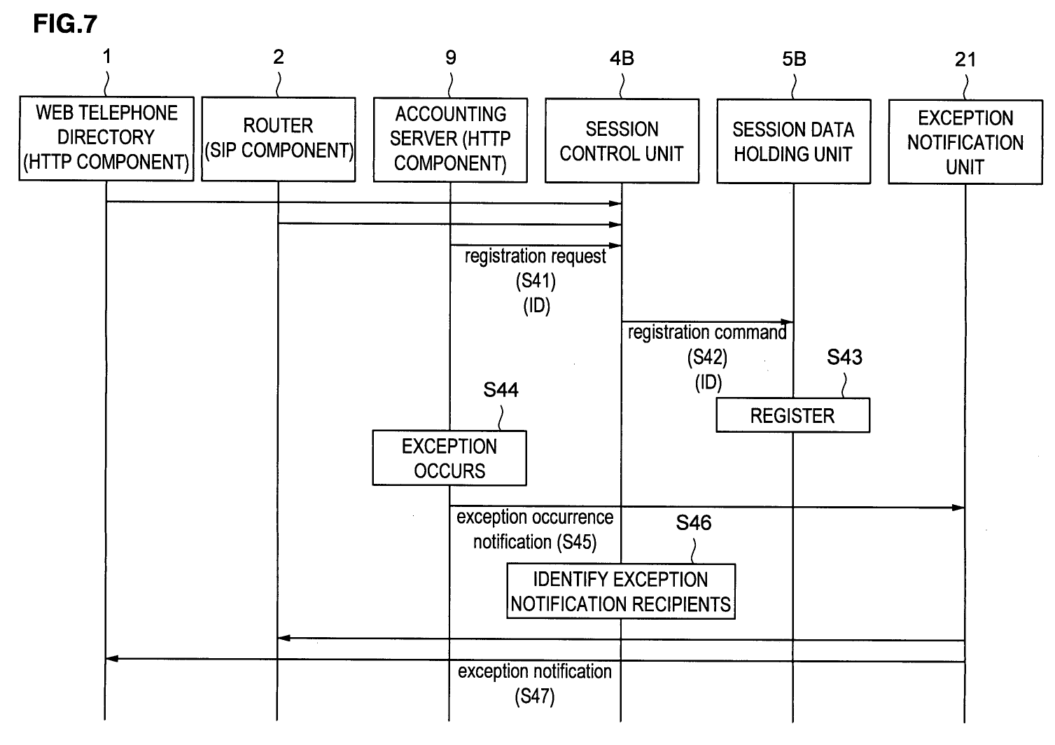

Next, the operation of the system 20 achieved in the embodiment is explained in reference to drawings. The following explanation is given on an example adopting the system configuration 21 shown in FIG. 6. In addition, FIG. 7 presents a flowchart of the operation executed by the system 21 in the embodiment.

FIG. 6 shows the system 20 that includes a Web telephone directory (an HTTP component), a router 2 (an SIP component) and an accounting server 9 (an HTTP component). It is to be noted that the same reference numerals are assigned in FIG. 6 to structural elements corresponding to those in FIG. 2.

First, the components 1, 2 and 9 each issue an exception notification registration request to the session control unit 4B so that it will be notified of any exception occurring at another component while all the components are engaged in processing in a single session as such a notification becomes necessary (S31, S41 in FIG. 7).

Upon receiving the exception notification registration requests from the individual components 1, 2 and 9, the session control unit 4B issues a command for the session data holding unit 5B to register them for exception notification (S32, S42 in FIG. 7). In response to the command issued by the session control unit 4B, the session data holding unit 5B registers the components requesting exception notifications (S43 in FIG. 7).

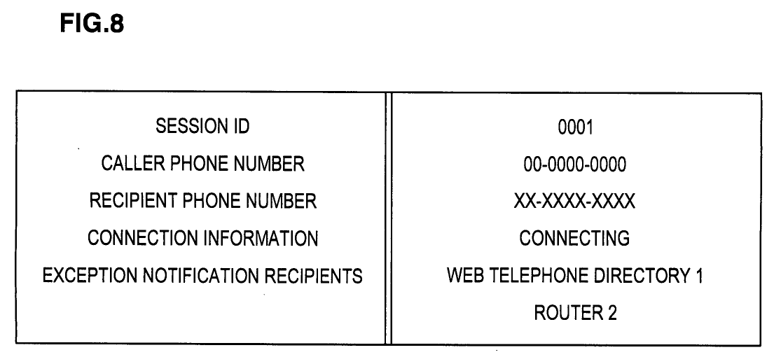

An example of exception notification registrations managed by the session data holding unit 5B at this time is now explained in reference to FIG. 8. The registration example in FIG. 8 includes a new management item, “exception notification recipients” in addition to the management items having been explained in reference to FIG. 4. This enables identification of the components 1, 2 and 9 requiring the exception notifications for each session. In addition, when registering exception notification recipients, identification numbers may be assigned to the individual components 1, 2 and 9 and the exception notification recipients may be registered in a list by using these identification numbers.

Let us now assume that an exception occurs subsequently at the accounting server 9 in FIGS. 6 and 7 (S44 in FIG. 7). While there are various types of exceptions that may occur at the accounting server 9, it is assumed in this example that the call invoice amount for the user A has exceeded the payment deposited with the accounting server 9 as a result of the most recent phone call made by the user A.

In other words, an exception occurs at the accounting server 9 when the telephone invoice amount for any user exceeds the payment deposited by the user. Upon the occurrence of the exception, the accounting server 9 issues an exception occurrence notification to the exception notification unit 21 (S33, S45 in FIG. 7).

As the exception notification unit 21 receives the exception occurrence notification, the session control unit 4B references the registration information on the registrations at the session data holding unit 5B and identifies the recipients that are to receive the exception notifications (S46 in FIG. 7). Then, the exception notification unit 21 issues the exception notifications to the identified recipient components (the Web telephone directory 1 and the router 2) (S34, S47 in FIG. 7).

By notifying the other participating components of the occurrence of an exception at a component that is part of the session, the occurrence of the exception can be reported to the other components that normally do not work together.

### (B-3) Advantages of the Second Embodiment

The embodiment only requires the individual components 1, 2 and 9 to transmit an exception occurrence notification to the exception notification unit 21 and to issue an exception notification request to the exception notification unit 21, and does not require any prearranged protocols defining specific components to report any occurrence of exceptions and specific components to be notified of exceptions. For this reason, less complex codes with a lower level of mutual dependency can be used to improve the development efficiency.

### (C) Third Embodiment

The third embodiment is explained in reference to drawings by focusing on the procedure to be followed when a component in the system, needing to execute processing through linkage with another component, calls up the service to be provided by the other component in the linked processing.

### (C-1) Structure of the Third Embodiment

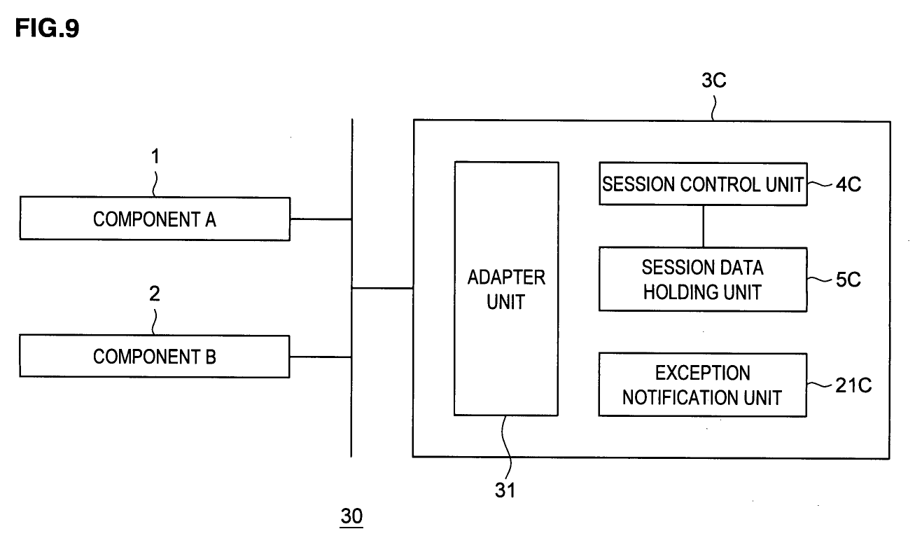

FIG. 9 is a functional block diagram schematically illustrating the functional structure of the system achieved in the embodiment.

As shown in FIG. 9, a system 30 achieved in the embodiment includes two components 1 and 2 and also includes a session management means 3C. It is to be noted that there are no particular restrictions imposed with regard to the types and the quantities of components 1 and 2.

The session management means 3C in the system 30 achieved in the third embodiment includes an adapter unit 31 that arranges for linked processing in response to a request issued by the component 1 or 2. Accordingly, a detailed explanation is given below on the functional structure of the adapter unit 31, and a repeated detailed explanation of the functional structures having been explained in reference to the first and second embodiments is omitted.

As shown in FIG. 9, the session management means 3C in the embodiment includes, at least, the adapter unit 31, a session control unit 4C, a session data holding unit 5C and an exception notification unit 21C.

When a linked processing request from the component 1 or 2 is received at the session management means 3C or when the other component 2 or 1 is to be engaged in response to a linked processing request, the session management means 3C functions as a mediator linking the applications (and the services) of the components. Namely, the adapter unit 31 receives a request from the application of the component 1 or 2, responds to the request and prepares a message in correspondence to the request.

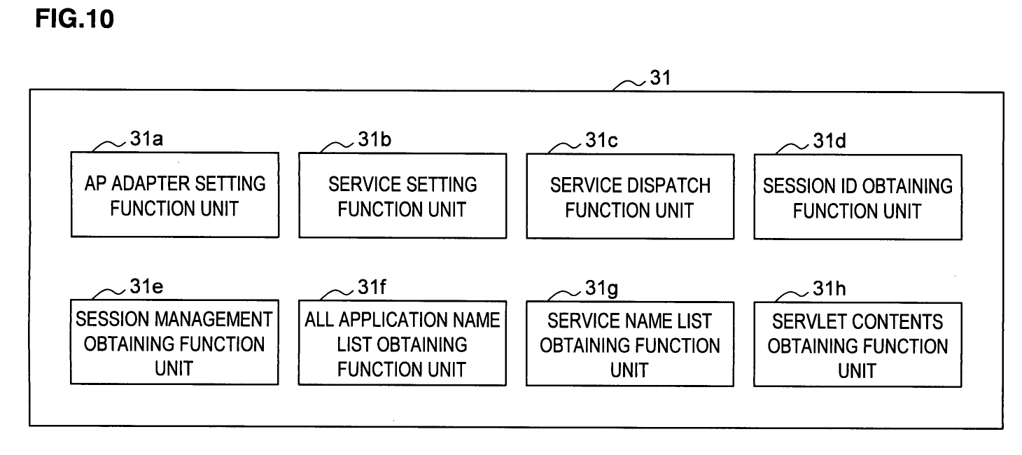

FIG. 10 shows the functions executed by the adapter unit 31. As shown in FIG. 10, the adapter unit 31 includes, at least, an AP adapter setting function unit 31a, a service setting function unit 31b, a service dispatch function unit 31c, a session ID obtaining function unit 31d, a session management obtaining function unit 31e, an all application name list obtaining function unit 31f, a service name list obtaining function unit 31g and a servlet contents obtaining function unit 31h.

Upon receiving a linked processing request from the component 1 or 2, the AP adapter setting function unit 31a generates a special adapter (an interface in software) corresponding to the application of the particular component 1 or 2 having issued the request. The adapter thus generated is referred to as an AP adapter in the explanation of the embodiment.

As a service name is specified by the service dispatch function unit 31c, the service setting function unit 31b generates a service interface (an interface in software) that will enable the execution of the service. The term “service” in this context refers to a service provided by a given application to another application.

The service dispatch function unit 31c executes dispatch processing for dispatching the service requested via the AP adapter.

When the application of the component 1 or 2 issues a dispatch request for a service provided by the other component, the session ID obtaining function unit 31d obtains the corresponding session ID from the session control unit 4C. It is to be noted that in order to execute a session with another application, all the participating applications need to be univocally correlated by using a single session ID. When session data are to be shared with the other applications, the session management obtaining function unit 31e issues a session management request to the session control unit 4C.

The AP adapter, which is a special adapter set in correspondence to the application type, is actually generated by the application by engaging the AP adapter setting function unit 31a in operation.

Various types of AP adapters is generated in correspondence to specific applications include, for instance, a Web adapter, an SIP adapter, a cooperation adapter, an integrated platform support adapter and a front end•portal development platform support adapter.

A Web adapter is an adapter for a Web application, which may be generated in response to, for instance, a request issued by the Web application in the HTTP component 1.

An SIP adapter is an adapter for an SIP, which may be generated in response to, for instance, a request issued by the SIP component.

A cooperation adapter is a special adapter used exclusively in conjunction with a specific application provided by the session management means 3C.

An integrated platform support adapter is an adapter compatible with a business process management•application integration platform.

A front end•portal development platform support adapter is an adapter compatible with a platform on which a front end portal is developed.

In addition, such AP adapters may each have functions inherent to it that match the corresponding application, as well as the functions (the basic functions) executed by the adapter unit 31.

For instance, the Web adapter described above may have a session tracking function with which the session ID is set as the attribute of a request (e.g., an Http Servlet Request) issued by the Web application for a shared information management session and a load balancing function with which the processing load is distributed among a plurality of servers with, for instance, a load balancer or the like, by invariably assigning processing in a single context (i.e., processing bearing a single session ID) to the same servers, in addition to the functions of the adapter unit 31 described above.

An explanation is now given on an example of a session tracking function operation.

(a) First, the session ID is searched based upon the request (e.g., an Http Servlet Request) issued by the Web application.

This search may be executed by, for instance, detecting the session ID with the cookie. Once the session ID is detected, the search ends.

If, on the other hand, the session ID is not present in the cookie, the session ID is detected from the query•string segment in the request URL. Once the session ID is detected, the search ends.

If the session ID is not found in the request URL either, the session ID is detected from the request parameters. If the session ID is detected in the request parameters, the search ends.

If the session ID cannot be detected from any of the data segments listed above, a new session ID is generated.

(b) Next, the session ID is set as the request attribute of the request. The session ID thus set can now be used by the Web adapter.

(c) Then, the session ID is set as a response (e.g., an Http Servlet Request).

If the session ID has been detected from the cookie, the session ID is automatically set for the response. Namely, the session is tracked by the cookie.

If the session ID has been detected from the query•string segment in the request URL, the session ID is set by using an Http Servlet Response wrapper having a session ID URL rewriting function for the response.

If no session ID has been detected, a session ID is set by using both the cookie function and the URL rewriting function.

With the adapter unit 31 at the session management means 3C equipped with these functions, the session can be tracked even in an environment that does not allow the Web application side to perform tracking.

Now, an explanation is given on an example of a Web adapter load-balancing function operation. Processing is assigned by the load balancer in response to an HTTP request by determining each assignee through the following procedure.

(a) If the HTTP session has already started, the assignee is determined based upon the HTTP session ID included in the request header.

(b) If a session requiring sharing of information has already been started, the assignee is determined based upon the session ID included in the request header.

(c) The assignee is determined at the discretion of the load balancer (e.g., randomly or through a round-robin).

### (C-2) Operation Executed in the Third Embodiment

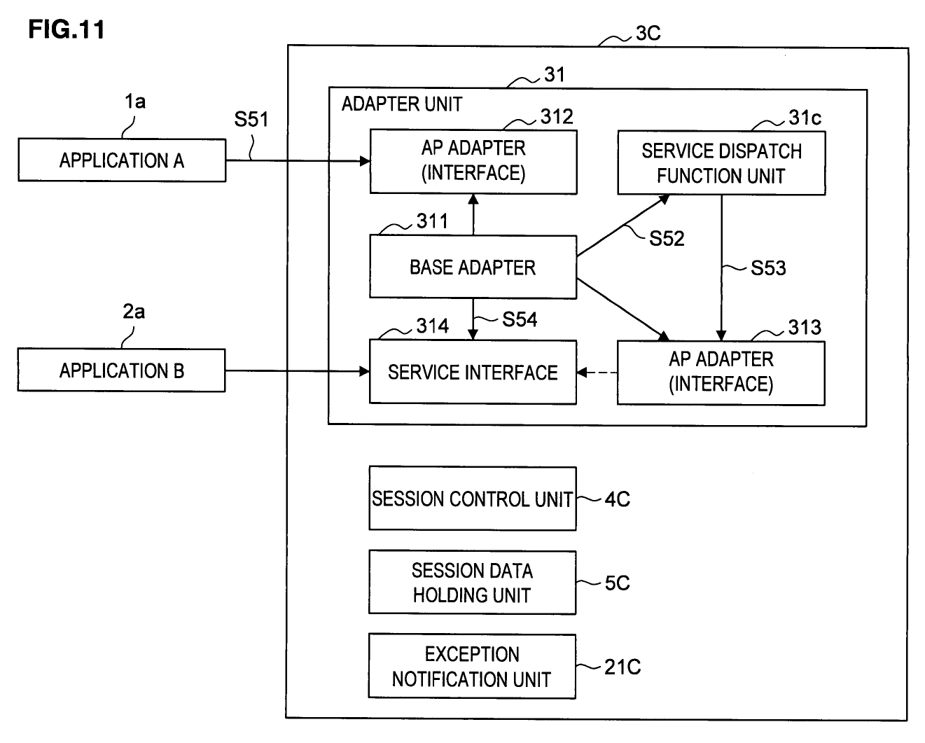

Next, the operation of the system 30 achieved in the embodiment is explained in reference to drawings. The following explanation is given on an example in which the system 30 adopts the structure shown in FIG. 11. FIG. 11 shows how the application 1a may dispatch a service available at the application 2a via the session management means 3C.

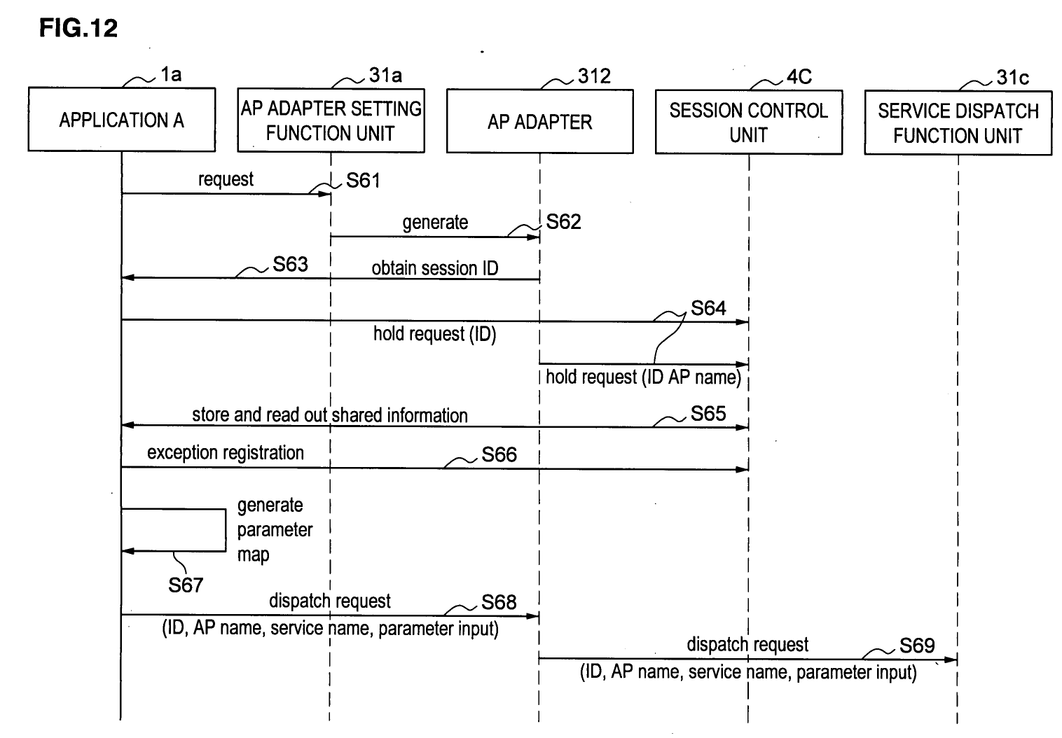

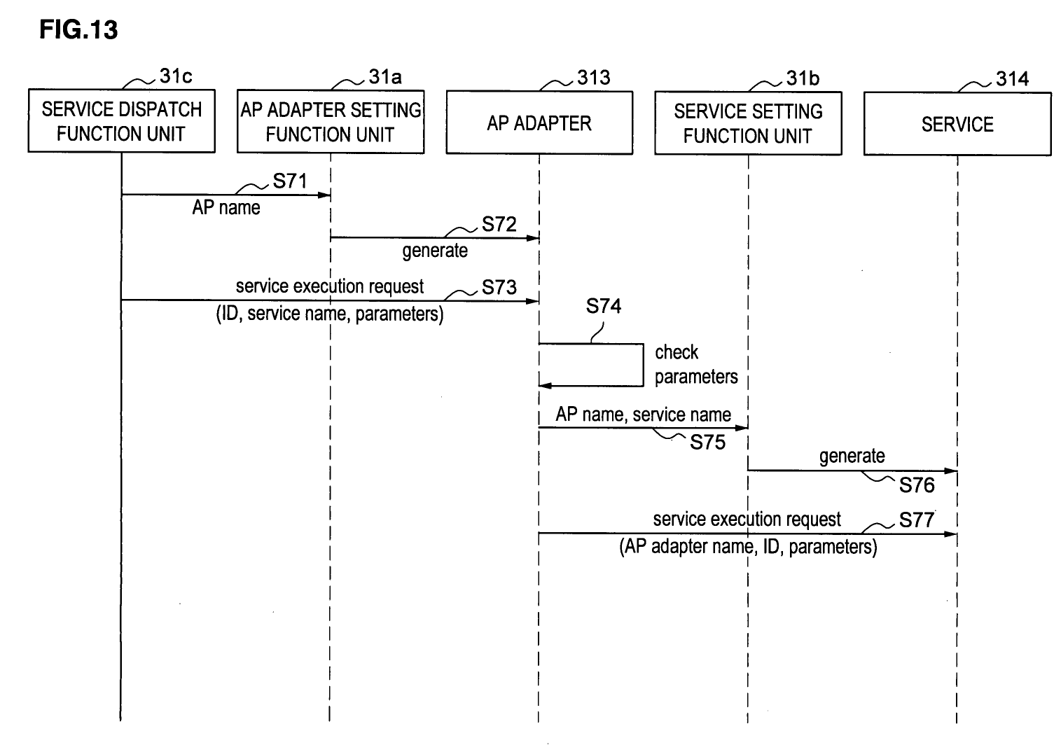

In addition, FIGS. 12 and 13 each present a sequence chart of the dispatch processing executed in the system 30. It is to be noted that a based adapter 311 in FIG. 11 embodies a package equipped with the various functions of the adapter unit 31.

First, the application 1a issues a processing request to the session management means 3C in FIG. 12. At this time, in response to the processing request from the application 1a, the AP adapter setting function unit 31a generates a special AP adapter 312 corresponding to the application 1a (S61 and S62).

Once the AP adapter 312 is generated, the application 1a obtains the session ID necessary for the session management by using the AP adapter 312 as an interface (S63). It is to be noted that the operation executed for the session ID generation is similar to the operation explained in reference to the first embodiment.

Once the session ID is generated, the application 1a issues a shared information hold request with regard to the linked processing to be achieved through linkage with the application 2a to the session control unit 4C via the AP adapter 312 (S64). At this time, the application 1a provides the AP adapter 312 with a request that contains the session ID, and the AP adapter 312, in turn, provides the session control unit 4C with the session ID and the application name of the application 1a.

Then, as in the first embodiment, a storage area is secured in correspondence to the session ID and subsequently, the shared information related to the linked processing is stored and read out by the session control unit 4C in response to a request from the application 1a (S65).

In addition, as in the second embodiment, the application 1a issues an exception notification registration request so that it will be notified of any exception occurring during the processing executed in the particular session (S66).

The application 1a then generates a parameter map that will be required for the service to be accessed (dispatched) (S67). When information is to be shared with the other application 2a, this parameter map is needed to transfer the shared information to the other application.

Next, the application 1a issues a dispatch request for the AP adapter 312 to the service of the other application 2a (S68, S51 in FIG. 11). At this time, the application 1a provides the AP adapter 312 with the session ID the application name, the service name and the parameters needed for the service.

In response to the request issued by the application 1a, the AP adapter 312 issues a dispatch processing request to the service dispatch function unit 31c (S69, S52 in FIG. 11). At this time, the AP adapter 312 provides the service dispatch function unit 31c with the session ID, the application name, the service name and the parameters required for the service.

Next, in reference to FIG. 13, the operation leading up to the execution of the service offered by the application 2a is explained.

Upon receiving the dispatch processing request in S69 in FIG. 12, the service dispatch function unit 31c provides the AP adapter setting function unit 31a with the name of the application in relation to which the dispatch processing has been requested (S71).

Then, the AP adapter setting function unit 31a generates an AP adapter 313 corresponding to the application 2a which is to provide the service (S72).

Once the AP adapter 313 is generated, the service dispatch function unit 31c issues a service execution processing request to the AP adapter 313 (S73, S53 in FIG. 11). At this time, the service dispatch function unit 31c provides the AP adapter 313 with the session ID, the service name and the parameters.

Upon receiving the service execution processing request from the service dispatch function unit 31c, the AP adapter 313 checks the essential parameters required for the service (S74) before the actual service is executed. Namely, it checks the parameters to ensure that the essential parameters among the service parameters registered in a setting file prepared in advance are set in the parameter map having been transferred for the service execution. It is to be noted that absence of the essential parameters in the parameter map may be followed by an occurring an exception during the service execution.

The AP adapter 313 provides the service setting function unit 31b with the application name and the service name (S75), and the service setting function unit 31b, in turn, generates a service interface 314 (S76).

Once the service interface 314 is generated, the AP adapter 313 issues a service execution request to the service interface 314 (S77, FIG. 11).

### (C-3) Advantages of the Third Embodiment

As described above, the third embodiment achieves advantages similar to those of the first and second embodiments.

### (D) Other Embodiments

(D-1) As described above, the shared information management programs for managing information shared among components and the shared information management methods for managing information shared among components, which are achieved in the individual embodiments of the present invention, may be adopted in application development for computer systems.

Accordingly, while the first through third embodiments have been explained in reference to systems in which SIP components and HTTP components operate in linkage, the present invention is not limited to these examples and may be adopted in a wide range of application development in general.

(D-2) While the systems 10 and 20 explained in reference to the first through third embodiments can each be built into any of various types of apparatuses, such a system may be installed in, for instance, a PBX apparatus having an SIP component and an HTTP component to enable the PBX apparatus to manage shared information when the SIP component and the HTTP component are engaged in linked processing. It goes without saying that the system may be adopted in conjunction with a wide range of communication apparatuses engaged in information communication at terminals included therein, other than a PBX apparatus.

While the invention has been particularly shown and described with respect to preferred embodiments thereof by referring to the attached drawings, the present invention is not limited to these examples and it will be understood by those skilled in the art that various changes in form and detail may be made therein without departing from the spirit, scope and teaching of the invention.

According to the present invention, a shared portion of information needed when a plurality of components constituting application software participate in linked processing can be managed effectively, which improves the efficiency of the application development and increases the productivity.

What is claimed is:

1. A component-shared information management program for managing information to be shared among a plurality of components constituting application software, that allows a computer to function as a shared information management means by enabling said computer to execute:
processing through which a registration request from a processing executing component among said plurality of components is received and a predetermined type of information is also received from said component; and
processing through which said information having been obtained is managed as shared information.

2. A component-shared information management program according to claim 1, which allows said shared information management means to achieve functions as a session control unit and a session data holding unit by enabling said computer to execute:
processing through which registration processing for said shared information is controlled in response to said registration request; and
processing through which said shared information is held at said session data holding unit in correspondence to each session of said component having issued said registration request.

3. A component-shared information management program according to claim 2, wherein:
said functions of said session control unit are achieved by enabling said computer to execute processing through which shared information required in a given session that is held at said session data holding unit is read out in response to a shared obtain information request issued by another component participating in linked processing in the session and the shared information thus read out is provided to said other component.

4. A component-shared information management program according to claim 1, which allows said shared information management means to function as an exception notification unit by enabling said computer to execute processing through which a notification indicating an exception occurrence is provided to one component or a plurality of components having been specified when an exception has occurred at one of said plurality of components.

5. A component-shared information management program according to claim 4, wherein:
when said shared information management means functions as said exception notification unit, each component to receive a notification is specified in response to a registration request issued by said component.

6. A component-shared information management program according to claim 1, wherein:
said shared information management means is allowed to function as an adapter unit by enabling said computer to execute processing through which registration processing for said shared information is mediated in correspondence to types of applications achieved by individual components.

7. A computer-readable recording medium having recorded therein a component-shared information management program according to claim 1.

8. A computer-readable recording medium having recorded therein a component-shared information management program according to claim 2.

9. A computer-readable recording medium having recorded therein a component-shared information management program according to claim 3.

10. A computer-readable recording medium having recorded therein a component-shared information management program according to claim 4.

11. A computer-readable recording medium having recorded therein a component-shared information management program according to claim 5.

12. A computer-readable recording medium having recorded therein a component-shared information management program according to claim 6.

13. A component-shared information management method for managing information to be shared among a plurality of components constituting application software, wherein:
a shared information management means receives a registration request from a processing executing component shared among said plurality of components, receives a predetermined type of information from said component and manages said information having been obtained as shared information.

14. A component-shared information management device for managing information to be shared among a plurality of components constituting application software, having:
a shared information management means that receives a registration request from a processing executing component to execute processing among said plurality of components, receives a predetermined type of information from said component and manages said information having been obtained as shared information.

15. A communication apparatus disposed between a single communication network or a plurality of communication networks and a single communication terminal or a plurality of communication terminals to enable said communication terminals to conduct information communication, which includes a component-shared information management device according to claim 14.
